(19) United States
(12) Patent Application Publication
(10) Pub. No.: US 2019/0126567 A1
(43) Pub. Date: May 2, 2019

(54) METHOD FOR MAKING A CHARGE AIR HOSE

(71) Applicant: ContiTech MGW GmbH, Hannoversch Muenden (DE)

(72) Inventors: Axel Bornemann, Katlenburg-Lindau (DE); Jens Juenemann, Suterode (DE); Martin Hoeer, Gehrden (DE)

(21) Appl. No.: 16/098,775

(22) PCT Filed: Feb. 27, 2017
(86) PCT No.: PCT/EP2017/054432

§ 371 Date: Nov. 2, 2018

(30) Foreign Application Priority Data
May 11, 2016 (DE) 10 2016 208 115.2

(51) Int. Cl. B29C 70/34

(52) U.S. Cl. CPC B29C 70/345; B29L 2023/005

(57) ABSTRACT

The disclosure relates to a method of making a charge air hose or pipe from plastic. It is an object to provide a method of making charge air hoses, by which charge air hoses are producible from continuous fiber-reinforced plastics with uniform wall thickness and an inner outline of high precision. Such a method can include the following steps: A) braiding a hose outline on a core using continuous fibers, B) laying the fiber braid together with the core into a cavity of an injection mold, C) injecting a low-viscosity free-flowing hardenable resin to impregnate the braided hose outline with the resin, D) hardening the impregnated component, and E) removing the component from the mold and removing the core.

### CROSS REFERENCE TO RELATED APPLICATIONS

This application is the national stage of PCT/EP 2017/054432, filed Feb. 27, 2017, designating the United States and claiming priority from German patent application no. 10 2016 208 115.2, filed May 11, 2016, the entire contents of which are incorporated herein by reference.

### FIELD OF THE INVENTION

The invention relates to a method of making a charge air hose or pipe from plastic.

### BACKGROUND OF THE INVENTION

For assurance of the functionality of the charge air system for internal combustion engines, rigid and flexible conduits are used for connection between turbocharger, resonator, charge air cooler and engine inlet. Owing to compact engine configurations, these components generally have a very complex geometry, that is, including one or more angles of curvature.

The geometric demands (internal tubular diameter) result from the amount of air to be transported, and the length of the hoses from the construction details of the engine space.

Taking account of the thermomechanical and chemical stresses, the rigid conduits, according to the current state of the art, are produced primarily from thermoplastics with or without fiber reinforcement by the blow-molding method and injection-molding method. Typical materials which are used for the components are commodity thermoplastics, for example, polypropylene (PP), engineering thermoplastics, for example, polyamide (PA), high-temperature thermoplastics, for example, polyphenylene sulfide (PPS), or thermoplastic elastomers (TPE).

DE 10 2014 110 747 discloses, for example, a pipe that has been blow-molded without reinforcing fibers.

A disadvantage of the blow-molding method are a high proportion of waste for technological reasons, an undefined surface in the interior of the hose and a nonuniform wall thickness over the component cross section, primarily in the region of angles of curvature. In regions of radii, the result is an accumulation of material on the inner diameter and a reduction in wall thickness on the outer diameter. In order to meet the thermomechanical demands, a minimum wall thickness has to be assured in all regions of the charge air hose, the effect of which is that a very high material input is needed and hence the wall thickness in straight sections of the charge air hose, for process-related reasons, is partly above the required minimum wall thickness.

In order to avoid the disadvantages of blow-molding technology, there are also known charge air hoses wherein the wall consists of fiber-reinforced plastics. DE 10 2012 208 363 proposes a charge air hose having a preform as extrusion component. However, the reinforcement materials are only applicable after the production of the preform.

This solution entails a multistage production process. Moreover, in the extrusion, the selection of the fibers available is limited, especially in terms of fiber length.

### SUMMARY OF THE INVENTION

It is an object of the invention to provide a method of making charge air hoses, via which charge air hoses are producible from continuous fiber-reinforced plastics with uniform wall thickness and an inner outline of high precision.

This object can, for example, be achieved via a method having the following steps:
A) braiding a hose outline on a core using continuous fibers,
B) laying the fiber braid together with the core into a cavity of an injection mold,
C) injecting a low-viscosity free-flowing hardenable resin to impregnate the braided hose outline with the resin,
D) hardening the impregnated component,
E) removing the component from the mold and removing the core.

This method gives rise to a hose having a thermoset matrix. Advantages of a thermoset matrix are high thermal and dimensional stability, very high surface quality and comparatively low material costs.

In an embodiment of the invention, the core is compressible.

The compressibility of the core has the advantage that, even in the case of hose forms that are relatively complex within certain limits, the core is still removable from the ready-hardened hose.

In an embodiment of the invention, the braiding is effected by means of an automatic circular braiding machine.

The use of automated machines makes the production of the hoses less costly.

In an embodiment of the invention, the continuous fibers are organic fibers.

In an embodiment of the invention, the continuous fibers are carbon fibers.

In an embodiment of the invention, the continuous fibers are polyamide fibers.

In an embodiment of the invention, the continuous fibers are polyester fibers.

In an embodiment of the invention, the continuous fibers are aramid fibers.

In an embodiment of the invention, the continuous fibers are natural fibers.

In an embodiment of the invention, the continuous fibers are flax fibers.

In an embodiment of the invention, the continuous fibers are inorganic fibers.

In an embodiment of the invention, the continuous fibers are glass fibers.

By virtue of the option of using a great variety of fibers for braiding, the method is adaptable to a broad spectrum of uses.

### BRIEF DESCRIPTION OF THE DRAWING

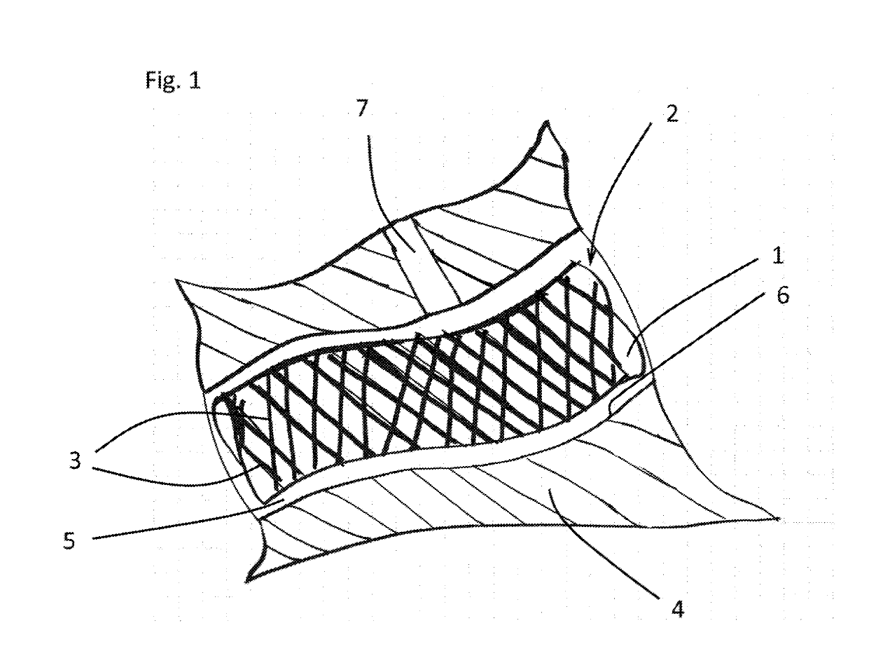

The invention will now be described with reference to the single FIGURE of the drawing (FIG. 1) which shows the step C) of the method of the invention in schematic form.

### DESCRIPTION OF THE PREFERRED EMBODIMENTS OF THE INVENTION

A braid 2 composed of continuous fibers 3 is braided onto a compressible core 1, in the form here of an inflatable hose. The core 1 with the braid 2, 3 is inserted into a longitudinally separable mold 4. A cavity 5 has been formed between the mold 4 and the fibers 3 braided onto the core 1. The core 1 is guided within the mold 4 by elements that are not shown here such that it comes to rest centrally within the cavity 5 of the mold 4. The radial distances between the wall 6 of the cavity 5 and the braid 2 are correspondingly equal everywhere on the left of the core.

The mold 4 has at least one injection opening 7, through which the cavity 5 is filled with a high-viscosity resin (not shown here). This not only fills the cavity 5 with resin, but also impregnates the braid 2 with resin.

After the hardening, the mold 4 can be opened and the core 1 with the now hardened impregnated braid 2 can be removed.

The inflatable core 1 can now be emptied and removed from the finished hose formed by the hardened braid 2.

It is understood that the foregoing description is that of the preferred embodiments of the invention and that various changes and modifications may be made thereto without departing from the spirit and scope of the invention as defined in the appended claims.

### LIST OF REFERENCE NUMERALS

### (Part of the Description)

1 compressible core
2 braid
3 continuous fibers
4 longitudinally separable mold
5 cavity in the mold 4
6 wall of the cavity 5
7 injection opening in the mold 5

1-12. (canceled)

13. A method of making a charge air hose from plastic, the method comprising the steps of:
braiding a hose outline on a core using continuous fibers;
layering the braided continuous fibers together with the core into a cavity of an injection mold;
injecting a low-viscosity free-flowing hardenable resin to impregnate the braided hose outline with resin so as to generate an impregnated component;
hardening the impregnated component;
removing the component from the mold and removing the core.

14. The method of claim 13, wherein the core is compressible.

15. The method of claim 13, wherein said braiding is effected via an automatic circular braiding machine.

16. The method of claim 13, wherein the continuous fibers are organic fibers.

17. The method of claim 16, wherein the continuous fibers are carbon fibers.

18. The method of claim 16, wherein the continuous fibers are polyamide fibers.

19. The method of claim 16, wherein the continuous fibers are polyester fibers.

20. The method of claim 16, wherein the continuous fibers are aramid fibers.

21. The method of claim 13, wherein the continuous fibers are natural fibers.

22. The method of claim 21, wherein the continuous fibers are flax fibers.

23. The method of claim 13, wherein the continuous fibers are inorganic fibers.

24. The method of claim 23, wherein the continuous fibers are glass fibers.
